(19) United States
(12) Patent Application Publication
(10) Pub. No.: US 2004/0162764 A1
(43) Pub. Date: Aug. 19, 2004

(54) Useful-information providing apparatus, method of providing useful information, and computer product

(75) Inventors: Aki Kita, Kawasaki (JP); Toshiharu Kido, Tokyo (JP); Tsutomu Tomomatsu, Kawasaki (JP); Masato Ageta, Kawasaki (JP); Mikiko Kimura, Kawasaki (JP); Akihiro Shimaya, Kawasaki (JP); Youichi Maruyama, Kawasaki (JP); Noriko Hozumi, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/744,131

(22) Filed: Dec. 24, 2003

(30) Foreign Application Priority Data
Jan. 15, 2003 (JP) 2003-007592

(51) Int. Cl. G06F 17/60

(52) U.S. Cl. 705/26

(57) ABSTRACT

Information about models of computers of a plurality of users and the information about software pre-installed in those computers is registered in a correlated manner as model data. In formation about models of the computers, information about software other than those pre-installed, and information about peripheral equipment that is connected to those computers are registered as user data. Information that is useful to the user and data of software and peripheral equipment that is necessary to use that information are stored as useful data. Information that is useful to a particular user is extracted and provided to that user based on the model data, the user data, and the useful data.

### BACKGROUND OF THE INVENTION

1) Field of the Invention

The present invention relates to a technology for providing useful information to a computer of a user via a network.

2) Description of the Related Art

Providing useful information to a computer of a user via network is a known technology. For example, Japanese Patent Application Laid-open Publication No. 2002-163503 discloses a method for providing a user, who wishes to purchase a certain product via a network, with information about related products when purchasing the same. Japanese Patent-Application Laid-open Publication No. 2001-306927 discloses a technology for providing tangible or intangible information of catalogues, samples, coupons, software etc. offered by client companies to users free of charge. Moreover, Japanese Patent Application Laid-open Publication No. 2001-24811 discloses a technology for providing information about customers to clients and Japanese Patent Application Laid-open Publication No. 2000-181969 discloses a technology for providing information about a dealing party.

It is also know to transmit information, which can be useful for effective use of user's computer (hardware and software) or peripheral equipment, to the user, by using information-communication network like the Internet.

However, when useful information is to be provided by using only the information-communication network, only information of general nature can only be provided since the requirement of information of specific nature varies from user to user. Therefore, it is the user who needs to judge which information is useful to him.

Assume that a user receives very useful information about a software. However, if the user doesn't intend to purchase that software, or if the user doesn't have a peripheral equipment to install that software, the information about the software is of not use to the user.

Ways and means for providing information, which is relevant and customized to the user, to the computer or peripheral equipment used by the user are being researched worldwide. Another important issue is to promptly provide information to the user about a software or a peripheral equipment that is necessary to effectively use the information sent to the user so that the user can use the information.

### SUMMARY OF THE INVENTION

It is an object of the present invention to at least solve the problems in the conventional technology.

A useful-information providing apparatus, according to one aspect of the present invention, provides useful information via a network to a first computer that is used by a user. This useful-information providing apparatus includes an extractor that automatically extracts useful information relating to software installed in a second computer that is possessed by the user; and a providing unit that provides the useful information extracted to the user.

A method of providing useful information via a network to a first computer that is used by a user, according to another aspect of the present invention, includes automatically extracting useful information relating to software installed in a second computer that is possessed by the user; and providing the useful information extracted to the user.

A computer program for realizing on a computer a method of providing useful information via a network to a first computer that is used by a user, according to still another aspect of the present invention, includes automatically extracting useful information relating to software installed in a second computer that is possessed by the user; and providing the useful information extracted to the user.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a functional block diagram of a useful-information providing system according to an embodiment of the present embodiment;

FIG. 2 is an example of contents of model data;

FIG. 3 is an example of contents of user data;

FIG. 4 is an example of contents of useful data;

FIG. 5 is an example of display of useful information;

FIG. 6A is another example of display of useful information;

FIG. 6B is still another example of display of useful information; and

FIG. 7 is a flow chart of a processing performed by a useful information extractor shown in FIG. 1.

### DETAILED DESCRIPTION

Exemplary embodiments of a useful-information providing apparatus, a method of providing useful information, and a useful-information providing computer program product relating to the present invention will be explained in detail below with reference to the accompanying drawings. The present embodiments relate to a case in which information is provided to a client machine (i.e., a computer) of a user, and that the client machine is connected to the WEB via the Internet.

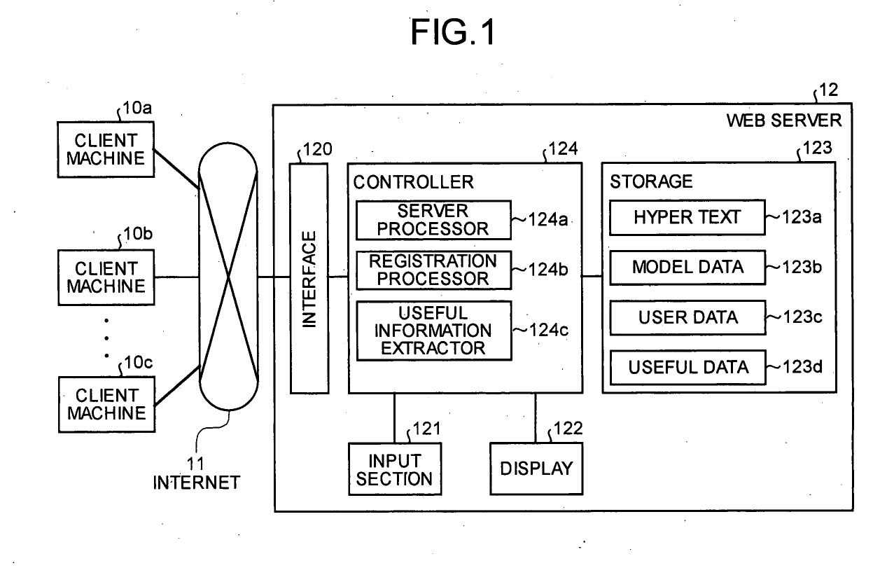

FIG. 1 is a functional block diagram of a useful-information providing system according to an embodiment of the present invention. This useful-information providing system includes a plurality of client machines 10a, 10b, and 10c that are connected to a WEB server 12 via the Internet 11.

The client machines 10a, 10b, and 10c are Internet client machines with a WEB browser is installed in these client machines 10a, 10b, and 10c. The WEB browser enables an access to a Hyper Text Transfer Protocol (hereinafter “HTTP”) server. The client machines 10a, 10b, and 10c can access to all servers on the Internet via a provider.

The WEB server 12 is the useful-information providing apparatus in the present invention. The WEB server 12 is an HTTP server that is accessed by the client machines 10a, 10b, and 10c on the Internet and provides web services like home page etc.

The WEB server 12 provides not only the general web service but also the useful information that is customized for environment of users of the client machines 10a, 10b, and 10c, in efficient manner. Concretely, the WEB server 12 provides the useful information that is customized for the software installed in or the hardware of the client machines 10a, 10b, and 10c, and peripheral equipment.

When the client machines 10a, 10b, and 10c do not have the software or the peripheral equipment that is necessary for using the useful information, the WEB server 12 provides information to the user about a homepage from where the user can purchase the software or the peripheral equipment. Thus, the user knows which software or peripheral equipment is required but lacking for using the useful information. The user can even purchase that software or peripheral equipment over the Internet.

The WEB server 12 includes an interface 120, an input section 121, a display 122, a storage unit 123, and a controller 124. The interface 120 is a network interface that transmits data to and receives data from the client machines 10a, 10b, and 10c, via the Internet 11. Concretely, the interface 120 performs processing according to Transmission Control Protocol/Internet Protocol (hereinafter “TCP/IP”). The WEB server 12 is a known computer that includes a CPU, a memory, a hard disc etc. A computer program to control the CPU is loaded in the memory. The computer program realizes a server processor 124a, a registration processor 124b, and a useful-information extractor 124c in the controller 124.

The input section 121 is an input device like a keyboard or a mouse. The display 122 is a display device like a liquid crystal panel. The storage unit 123 is a storage device like hard disc etc. and has a hyper text 123a, model data 123b, user data 123c, and useful data 123d stored in it.

The hyper text 123a forms a display screen of WEB browser that is transmitted to the client machines 10a, 10b, and 10c.

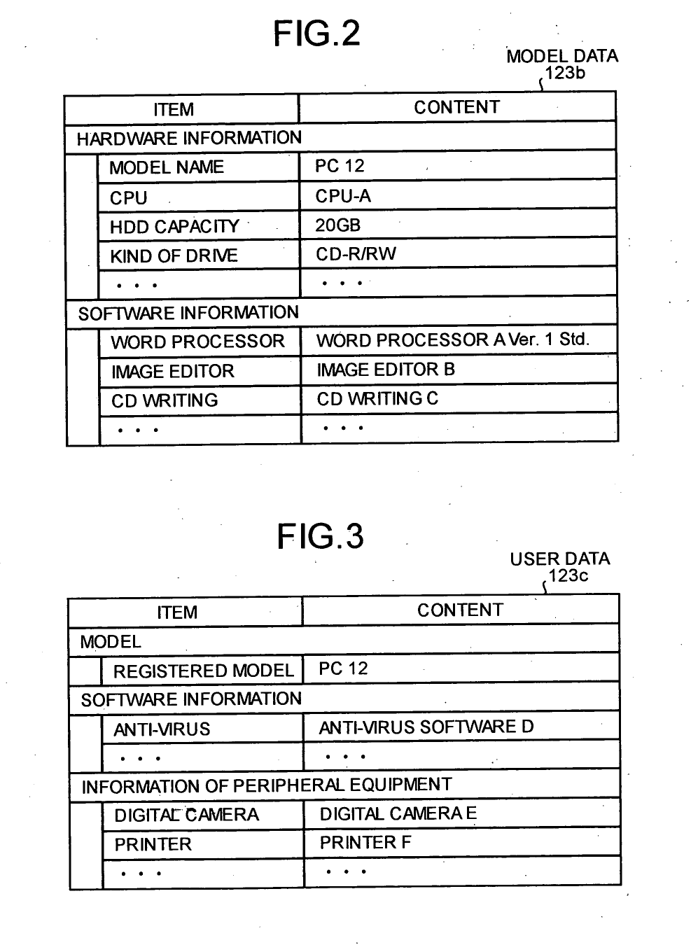

The model data 123b includes hardware information and software information for each model of computer. FIG. 2 is an example of contents of the model data 123b. The hardware information includes items such as a model name (PC 12), CPU (CPU-A), hard disc capacity (20 G), kind of a drive (CD-R/RW) etc. Software information includes items such as a word processor software (Word Processor A Ver. 1 Std.) that is a software pre-installed in the computer before shipment of the computer model, image editor (image editor B), CD writing software (CD writing C) etc. Thus, just by knowing the model that is used by the user, the information of computer hardware and software installed can be obtained.

The user data 123c includes items such as model that is the information about a model of the computer used by the user, software that is the software (other than the pre-installed software) purchased by the user, and peripheral equipment that is information about the peripheral equipment connected to the computer used by the user. FIG. 3 is an example of contents of the user data 123c. The item model includes the name of a computer (PC 12). The item software information includes a list of the anti-virus softwares (anti-virus software D) purchased by the user. The item peripheral equipment includes a list of peripherals such as digital cameras (digital camera E), printers (printer F) etc. Thus, by tracing the model data 123b based on the information of the model, the information of the hardware and the pre-installed software can be obtained. In addition to this, from the software information in the user data 123c, the software purchased by the user other than the pre-installed software can be known. Moreover, from the information of the peripheral equipment, the peripheral equipment used by the user can be known.

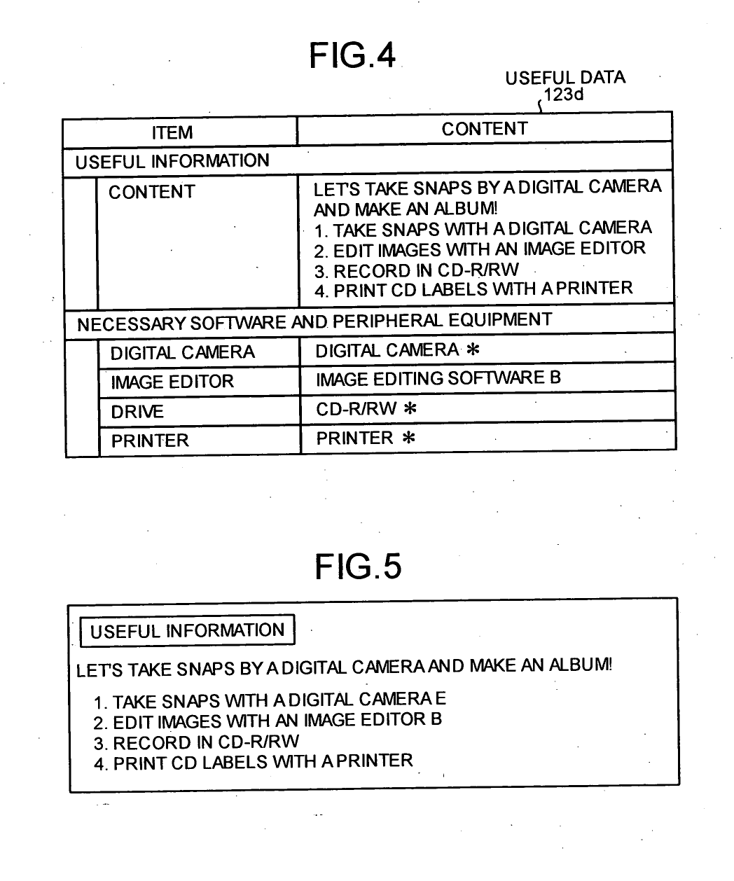

The useful data 123d includes useful information that is information necessary for efficient use of the client machines 10a, 10b, and 10c by using the software and peripheral equipment, and necessary software and peripheral equipment that is information about the software and the peripheral equipment that are required for using the useful information. FIG. 4 is an example of contents of the useful data 123d. The item useful information includes a procedure for making an original album. The item necessary software and peripheral equipment includes a list of software such as image editing software (B) and a list of peripheral equipment such as digital cameras, drives (CD-R/RW), and printers etc., that are necessary for making the original album. An asterisk after the name in FIG. 4 indicates that a category is registered. Only the category may be registered instead of registering the actual name of the software and the peripheral equipment.

The controller 124 controls the WEB server 12 and includes the server processor 124a, the registration processor 124b, and the useful-information extractor 124c. The server processor 124a provides a function of an HTTP server to the client machines 10a, 10b, and 10c. Concretely, when the client machines 10a, 10b, and 10c assess the server processor 124a, the server processor 124a reads out the hyper text 123a that is stored in the storage unit 123 and transmits the hyper text 123a to the corresponding client machine.

The registration processor 124b, jointly with the server processor 124a, performs registration processing of the model data 123b, the user data 123c, and the useful data 123d that are stored in the storage unit 123. Concretely, a page for registration processing is prepared on a home page that is provided by the server processor 124a. When data is input on this home page, the input result is reflected in the model data 123b, the user data 123c, and the useful data 123d. When the input result is reflected, data registration of the model data 123b and the useful data 123d is performed mainly by a system manager and data registration of the user data 123c is performed by the user. The data registration may be performed automatically by joint action (data transfer) of the client machines 10a, 10b, and 10c of users instead of by using the page for the registration processing.

The useful information extractor 124c automatically extracts the useful information about the hardware, the software, and the peripheral equipment of the client machines 10a, 10b, and 10c of users. The useful information extractor 124c also automatically extracts a sales page of the software and the peripheral equipment that are lacking for using the useful information, if necessary.

For example, in a case of a user having the user data 123c illustrated in FIG. 3, since the user is using the PC 12, the user has the image-editing software (B) and CD writing (C) as pre installed software. The user further has the digital camera (E) and the printer (F) as the peripheral equipment. Whereas, in the useful information shown in FIG. 4, a digital camera, the image editing software B, the CD-R/RW, and a printer are necessary. Thus, the useful information extractor 124c extracts the useful data that can be used in user's environment and associates it with the corresponding user.

The useful information extractor 124c extracts the useful information for each user and converts it into a hyper text in advance. When the user makes an access to the home page, the useful-information extractor 124c displays the useful information for the corresponding user on the home page. FIG. 5 is an example of a display of the useful information. The useful information in this example is the procedure for making the original album using the software and the peripheral equipment.

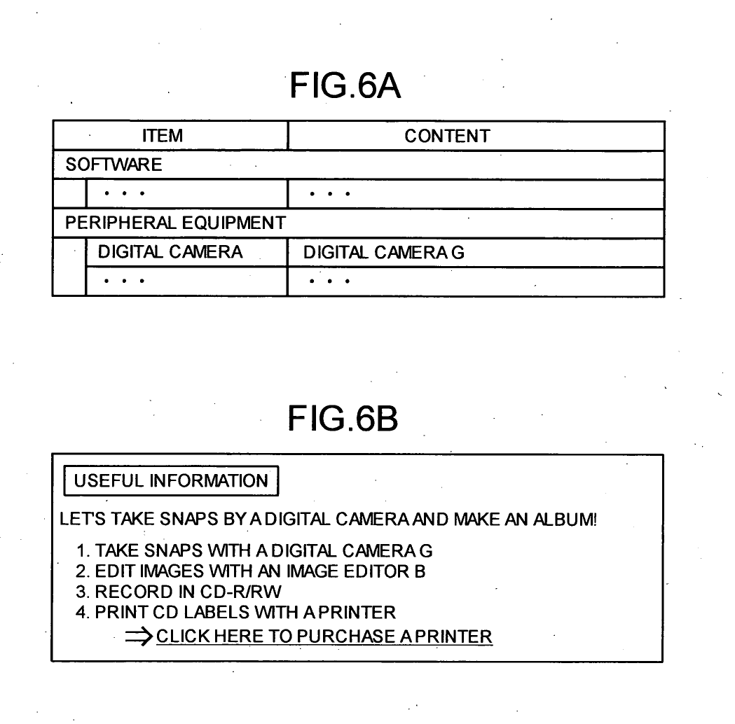

FIG. 6A and 6B are other examples of display of the useful information. In this example, the user has a digital camera (G) but has no printer (see FIG. 6A), so that the useful information as illustrated in FIG. 6B is displayed. In other words, the name of the digital camera in the procedure for making the original album becomes digital camera (G). Moreover, since the user has no printer, a link to a homepage where a printer can be purchased is provided.

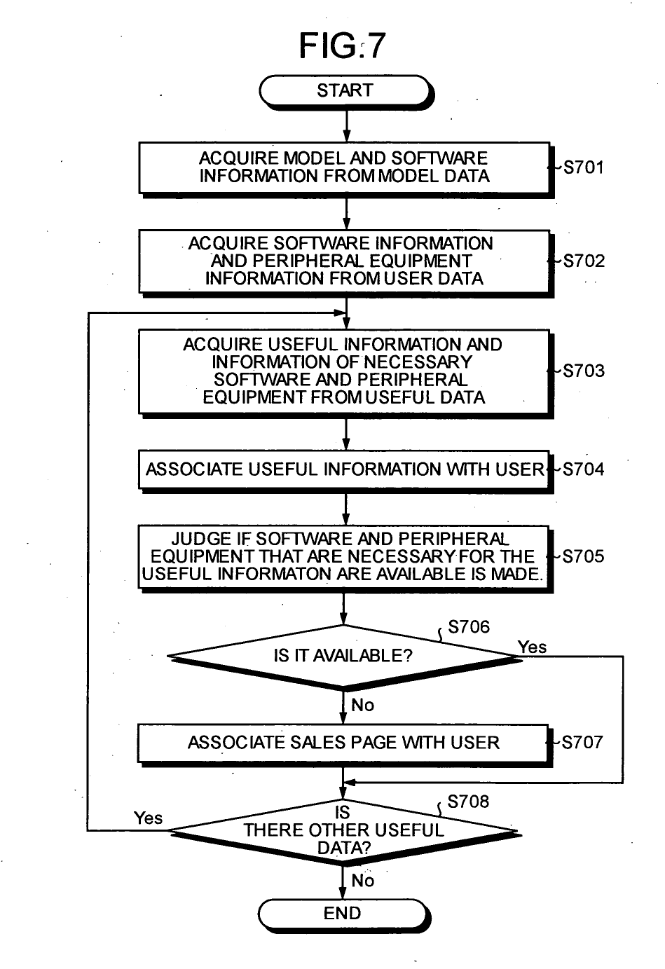

FIG. 7 is a flow chart of a processing performed by the useful information extractor 124c. For convenience, only a case of extraction of useful information for user AAA that has the client machine 10a is mentioned here.

The useful-information extractor 124c acquires the model and the software information (of the pre-installed software) from the model data 123b (step S701). Moreover, acquires the software information (other than the information of the pre-installed software) and the information of the peripheral equipment from the user data 123c (step S702). From this information, the useful-information extractor 124c identifies all the softwares that are installed in the client machine 10 and the peripheral equipment.

All the users who access the WEB server 12 may be provided with an identification number (hereinafter “ID”) so that the users can be identified. In other words, a peculiar ID is assigned to the user in advance. When the user inputs the ID while making an access to the home page, the WEB server 12 can identify the user that has made an access. Further, by registering the ID as an item in the user data in FIG. 3, the user data corresponding to the user can be specified by using the ID that is input by the user.

Then the useful-information extractor 124c acquires the useful information and information of the software and the peripheral equipment that are required from the useful data 123d (step S703). The useful information is associated with the user AAA (step S704) and judgment of if the software and the peripheral equipment that are necessary for the useful information are available is made (step S705).

If it is not available with the user AAA (step S706) the sales page for the corresponding software and the peripheral equipment is associated with the user (step S707) and existence of any other useful data is checked (step S708). If any other useful data is there (step S708 affirmation), the process returns to step S703 and similar process is repeated. If there is no other useful data (step 708 negation), the process ends.

The server processor 124a, thus, inserts the information that is extracted and formed by the useful-information extractor 124c into the hyper text 123a and provides this information to the client machine 10a that makes an access. Thus, useful information that is customized for an environment of the user that uses the client machine 10a is displayed in the WEB browser of the client machine 10a.

By performing a series of processes, the useful information can be provided by presenting the sales home page about the software and peripheral equipment that are lacking in the user's environment. In this description, for convenience all the useful information is provided to the user. However, filtering can be incorporated to not to provide the useful information to a user that does not have a major part of the software and the peripheral equipment that is necessary. Thus, the customized useful-information can be provided to the user.

Thus, in the present embodiment, the information of software that is pre-installed in the computer is registered by the registration processor 124b as the model data 123b for each model. The information of user's computer model, the software other than the pre-installed software, and the peripheral equipment are registered by the registration processor 124b as the user data 123c. The useful information as the data of the software and the peripheral equipment that are required for the useful information are registered as the useful data 123d. The useful-information extractor 124c extracts and provides the useful data that is suitable for the user. Due to such structure, each user can have customized useful-information.

In the present embodiment, the extraction of the useful data based on the software and the peripheral equipment that are available with the user, by the useful-information extractor 124c is mentioned. It is also possible to have a structure in which the useful information extractor 124c extracts a product based on information of software as well as hardware. Concretely, the structure is made such that if specifications like the processing speed of the CPU or the memory are not sufficient to execute the useful information, the useful information is not provided.

Further, in the present embodiment, the useful information is extracted in advance for each user and when an access is made by the user from the client machines 10a, 10b, and 10c, the useful information is provided. It is also possible to extract useful information that is suitable for the user whenever an access is made.

In the present embodiment, a case of providing the useful information on Web has been explained. However, the present invention is not restricted to this case only and the useful information can also be provided by news, mail etc. For example, in a case of providing the useful information by using mail, the WEB server 12 is equipped with a function to transmit mails to users of the client machines 10a, 10b, and 10c and the useful information may be transmitted by mail.

In the present embodiment, the WEB server 12 includes the input section 121 and the display 122. However, this structure is not indispensable. When the WEB server 12 does not include the input section 121 and the display 122, the system manager can make an access to the WEB server 12 by using a client machine that has an input section and a display, and necessary data may be registered.

Thus, the present invention enables to provide useful information that is customized for user's computer and peripheral equipment, in efficient manner.

Thus, the present invention enables to provide useful information that is customized for user's software and peripheral equipment, in efficient manner.

Moreover, the present invention enables to provide useful information that is customized for user's software, computer hardware, and peripheral equipment.

Furthermore, the present invention enables to provide useful information that is customized for user's environment by using these data.

Moreover, the present invention enables to inform the user promptly about software and peripheral equipment that are lacking in the environment for using the useful information and to buy these software and peripheral equipment if desired.

Furthermore, the present invention enables to provide the useful information using the existing network, in efficient manner.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A useful-information providing apparatus that provides useful information via a network to a first computer that is used by a user, comprising:
an extractor that automatically extracts useful information relating to software installed in a second computer that is possessed by the user; and
a providing unit that provides the useful information extracted to the user.

2. The useful-information providing apparatus according to claim 1, wherein the extractor automatically extracts the useful information that relates to peripheral equipment that is connected to the second computer.

3. The useful-information providing apparatus according to claim 1, wherein the extractor automatically extracts the useful information that relates to software installed in the second computer, relates to hardware of the second computer, and relates to peripheral equipment that is connected to the second computer.

4. The useful-information providing apparatus according to claim 3, further comprising a storage unit that stores
model data that includes information relating to the hardware of the second computer and a information relating to a first software that is a software that is pre-installed in the second computer,
user data that includes information relating to a model of the second computer, information relating to a second software that is a software other than the first software, and information of peripheral equipment that is information relating to the peripheral equipment that is connected to the second computer, and
useful data that includes useful information that is to be provided to the user and information relating to software and equipment that are necessary to use the useful information, wherein
the extractor automatically extracts the useful information that relates to the software, and at least one of the hardware and peripheral equipment of the second computer, based on the model data, the user data, and the useful data.

5. The useful-information providing apparatus according to claim 4, wherein the extractor extracts information regarding sales of the software and the peripheral equipment together with the useful information when the user does not have the software and the peripheral equipment that is necessary to use the useful information.

6. The useful information providing apparatus according to claim 1, wherein the providing unit provides the useful information to the user by at least any one of mail, news, and WEB service on the Internet.

7. A method of providing useful information via a network to a first computer that is used by a user, comprising:
automatically extracting useful information relating to software installed in a second computer that is possessed by the user; and
providing the useful information extracted to the user.

8. The method according to claim 7, wherein the extracting includes automatically extracting the useful information that relates to peripheral equipment that is connected to the second computer.

9. The method according to claim 7, wherein the extracting includes automatically extracting the useful information that relates to software installed in the second computer, relates to hardware of the second computer, and relates to peripheral equipment that is connected to the second computer.

10. The method according to claim 9, further comprising storing
model data that includes information relating to the hardware of the second computer and a information relating to a first software that is a software that is pre-installed in the second computer,
user data that includes information relating to a model of the second computer, information relating to a second software that is a software other than the first software, and information of peripheral equipment that is information relating to the peripheral equipment that is connected to the second computer, and
useful data that includes useful information that is to be provided to the user and information relating to software and equipment that are necessary to use the useful information, wherein
the extracting includes automatically extracting the useful information that relates to the software, and at least one of the hardware and peripheral equipment of the second computer, based on the model data, the user data, and the useful data.

11. The method according to claim 10, wherein the extracting includes extracting information regarding sales of the software and the peripheral equipment together with the useful information when the user does not have the software and the peripheral equipment that is necessary to use the useful information.

12. The method according to claim 7, wherein the providing includes providing the useful information to the user by at least any one of mail, news, and WEB service on the Internet.

13. A computer program for realizing on a computer a method of providing useful information via a network to a first computer that is used by a user, comprising:
automatically extracting useful information relating to software installed in a second computer that is possessed by the user; and
providing the useful information extracted to the user.

14. The computer program according to claim 13, wherein the extracting includes automatically extracting the useful information that relates to peripheral equipment that is connected to the second computer.

15. The computer program according to claim 13, wherein the extracting includes automatically extracting the useful information that relates to software installed in the second computer, relates to hardware of the second computer, and relates to peripheral equipment that is connected to the second computer.

16. The computer program according to claim 15, further comprising storing
model data that includes information relating to the hardware of the second computer and a information relating to a first software that is a software that is pre-installed in the second computer,
user data that includes information relating to a model of the second computer, information relating to a second software that is a software other than the first software, and information of peripheral equipment that is information relating to the peripheral equipment that is connected to the second computer, and
useful data that includes useful information that is to be provided to the user and information relating to software and equipment that are necessary to use the useful information, wherein
the extracting includes automatically extracting the useful information that relates to the software, and at least one of the hardware and peripheral equipment of the second computer, based on the model data, the user data, and the useful data.

17. The computer program according to claim 16, wherein the extracting includes extracting information regarding sales of the software and the peripheral equipment together with the useful information when the user does not have the software and the peripheral equipment that is necessary to use the useful information.

18. The computer program according to claim 13, wherein the providing includes providing the useful information to the user by at least any one of mail, news, and WEB service on the Internet.
